(19) United States
(12) Patent Application Publication
(10) Pub. No.: US 2020/0065792 A1
(43) Pub. Date: Feb. 27, 2020

(54) INFORMATION PROCESSING DEVICE

(71) Applicant: TOSHIBA TEC KABUSHIKI KAISHA, Tokyo (JP)

(72) Inventors: Hitoshi IIZAKA, Fuji Shizuoka (JP); Hidehiro NAITO, Mishima Shizuoka (JP); Hidehiko MIYAKOSHI, Mishima Shizuoka (JP); Yuki KAWAGUCHI, Tagata Shizuoka (JP); Naoki OGOMORI, Izunokuni Shizuoka (JP)

(21) Appl. No.: 16/521,420

(22) Filed: Jul. 24, 2019

(30) Foreign Application Priority Data
Aug. 23, 2018 (JP) 2018-156707

(51) Int. Cl. G06Q 20/20; G06K 9/00; G06K 7/14; B62B 5/00; H04W 4/35

(52) U.S. Cl. CPC G06Q 20/208; G06K 9/00201; H04W 4/35; B62B 5/0096; G06K 7/1404

(57) ABSTRACT

An information processing device on a shopping basket or cart includes a communication interface configured to communicate with an imaging device installed on the shopping basket or cart and beacons installed on a product display area displaying a commodity, and a processor configured to, identify a commodity by either reading a commodity code in the image or performing object recognition on the image, and, according to a signal received from at least one beacon, switch between a first mode, in which the commodity can be identified by reading the commodity code, and a second mode, in which the commodity can be identified by either reading the commodity code or object recognition.

### CROSS-REFERENCE TO RELATED APPLICATION

This application is based upon and claims the benefit of priority from Japanese Patent Application No. 2018-156707, filed in Aug. 23, 2018, the entire contents of which are incorporated herein by reference.

### FIELD

Embodiments described herein relate generally to an information processing device.

### BACKGROUND

There are information processing devices, such as Point of Sale (POS) terminals, that identify a commodity to be purchased by a customer with generic object recognition or the like. Further, there are information processing devices that identify a commodity either by performing the object recognition or by scanning of a code symbol attached to the commodity, such as a barcode.

It is typically considered that a commodity is identified more accurately and rapidly by the scanning of the code symbol rather than by use of object recognition. Therefore, these information processing apparatuses preferentially perform scanning of the code symbol for any commodity on which the code symbol can be detected, and performs object recognition only on those commodities on which a code symbol is not attached or not detected. Often, commodity items, such as fruits and vegetables, do not have a code symbol attached and these items require analysis of exterior characteristics to identify.

However, in existing information processing devices capable of executing both scanning of the code symbol and object recognition, an inconvenience could occur in which object recognition is executed on an unintended article, that is, an article to which a code symbol has been attached, but which was not detected prior to initiation of object recognition processing on the article.

### DESCRIPTION OF THE DRAWINGS

FIG. 1 is a perspective view illustrating the exterior of an information processing device in a first embodiment.

FIG. 2 is a diagram illustrating an example of a hardware configuration of the information processing device.

FIG. 3 is a diagram illustrating an example of a hardware configuration of a beacon terminal.

FIG. 4 is a diagram illustrating functional aspects in a controller of the information processing device.

FIG. 5 is a flowchart illustrating an example of processing executed by the information processing device.

FIG. 6 is a diagram illustrating disposition of beacon terminals in a store in a second embodiment.

FIG. 7 is a diagram illustrating a positional relation between the information processing device and beacon terminals.

FIG. 8 is a flowchart illustrating a flow of processing executed by the information processing device.

### DETAILED DESCRIPTION

An information processing device according to one embodiment can reduce unnecessary performance of generic object recognition on commodities having a bar code or the like.

According to one embodiment, an information processing device on a shopping basket or a shopping cart includes a communication interface configured to communicate with an imaging device on the shopping basket or the shopping cart and a beacon at a product display area, and a processor configured to identify the commodity by either reading a commodity code in an image or object recognition on the image, and according to on a signal received from at least one beacon, switch between a first mode where the commodity is identified by reading the commodity code, and a second mode where the commodity can be identified by either reading the commodity code or object recognition.

### First Embodiment

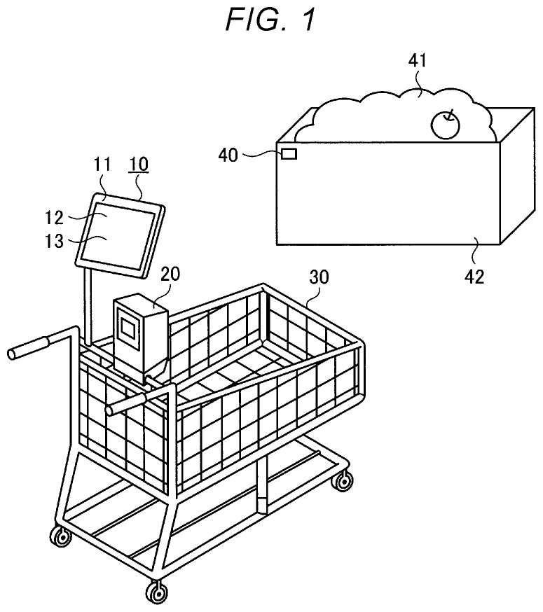

A first embodiment is explained with reference to the drawings. FIG. 1 is a perspective view illustrating the exterior of an information processing device 10 in this embodiment. The information processing device 10 is attached to, together with a reading device 20, a shopping cart 30 or a shopping basket used for storing commodities in a retail store. The information processing device 10 operates as a sales data processing device that registers the commodities to be purchased, that is, records information concerning the commodities, and a commodity information presenting device that presents information concerning substitutable commodities.

The information processing device 10 has an exterior and functions like a tablet computer or a tablet terminal and includes a main body 11, a display 12, and an input device 13.

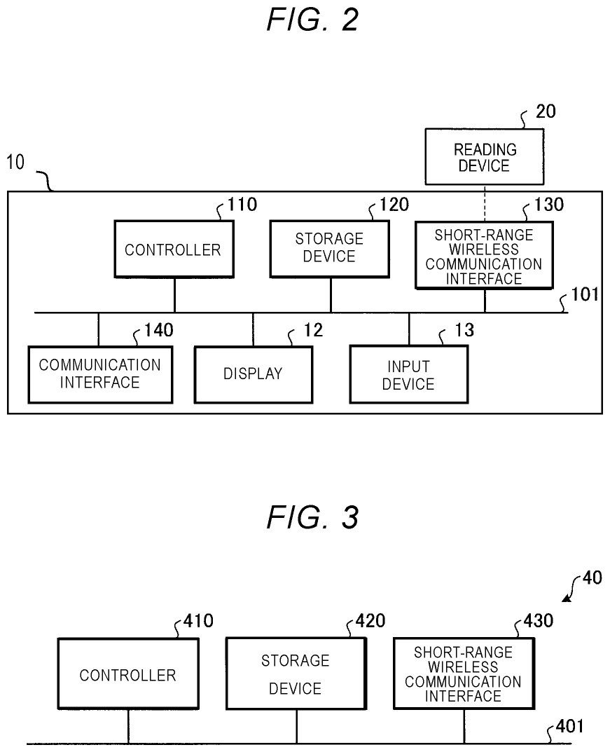

FIG. 2 is a diagram illustrating an example of a hardware configuration of the information processing device 10. The information processing device 10 further includes a controller 110, a storage device 120, a short-range wireless communication interface 130, and a communication interface 140. The controller 110, the storage device 120, the short-range wireless communication interface 130, the communication interface 140, the display 12, and the input device 13 are connected to one another via a system bus 101 such as a data bus or an address bus.

The display 12 is a tabular display device such as a liquid crystal display. The input device 13 is a touch panel superimposed on the surface of the display 12. The main body 11 is a thin box-like housing having an opening on one surface. The main body 11 houses the hardware components explained above (e.g., the controller 110, the storage device 120, the short-range wireless communication interface 130, the communication interface 140, the display 12, and the input device 13). The opening of the main body 11 exposes a region where the input device 13 receives an input by an operator.

The controller 110 is a computer component and includes a CPU (Central Processing Unit), a ROM (Read Only Memory), and a RAM (Random Access Memory). The ROM is a non-volatile memory that stores various computer programs and data. The RAM is a volatile memory that temporarily stores various computer programs and various data. The CPU executes the computer programs stored in the ROM and the storage device 120 to achieve various operations of the information processing device 10.

The storage device 120 is a storage device such as an HDD (Hard Disk Drive) or an SSD (Solid State Drive). The storage device 120 stores various computer programs executable by the controller 110 (e.g., CPU), setting information, and the like.

The storage device 120 stores a PLU (Price look-up) file therein. The PLU file stores commodity codes, which are uniquely allocated to commodities, and commodity information, such as names, unit prices, and classifications, in association with each other. The PLU file also stores feature values, reference images, and the like of commodities, which are used by the information processing device 10 in specifying the commodities through object recognition. The feature values are data such as colors of the commodities, unevenness of the surfaces of the commodities, and the like, read from the reference images of the commodities.

The communication interface 140 is a communication interface for communicating with a server apparatus and other information processing terminals, both of which are not illustrated in FIG. 2, through wireless LAN communication, mobile communication, or the like.

In this embodiment, as shown in FIG. 1, a beacon terminal 40 is installed on a product display area 42 such as display case, bin, shelf, or the like where commodities without code symbol 41, such as vegetables and fruits, are displayed. The beacon terminal 40 may be installed on or near any object used for displaying a commodity in a store. The commodity without code symbol 41 is a commodity on which a code symbol such as a barcode or a two-dimensional code is not attached. The information processing device 10 includes a functional section (explained below) that performs predetermined processing upon reception of a radio wave emitted by the beacon terminal 40.

FIG. 3 is a diagram illustrating an example of a hardware configuration of the beacon terminal 40. The beacon terminal 40 includes a controller 410, a storage device 420, and a short-range wireless communication interface 430. These hardware components are connected to one another via a system bus 401 such as a data bus or an address bus.

The controller 410 includes computer components such as a CPU, a ROM, and a RAM. The ROM is a nonvolatile memory that stores various computer programs and data. The RAM is a volatile memory that temporarily stores various computer programs and rewrites various data. The CPU executes the computer programs stored in the ROM and the storage device 420 to achieve various operations of the beacon terminal 40.

The storage device 420 is a storage device such as a flash memory and stores beacon IDs, distribution information, and the like.

The short-range wireless communication interface 430 is a communication interface for short-range wireless communication such as BLE (Bluetooth Low Energy) or a Bluetooth-type protocol. The short-range wireless communication interface 430 communicates with the information processing device 10 and the like present within a communication zone.

The controller 410 of the beacon terminal 40 distributes the beacon IDs and the distribution information stored in the storage device 420 from the short-range wireless communication interface 430 by broadcasting the beacon IDs and the distribution information to each of information processing devices 10 present within the communication zone.

In the information processing device 10, the short-range wireless communication interface 130 performs communication with the beacon terminal 40. The short-range wireless communication interface 130 is a communication interface for performing short-range wireless communication such as BLE. The short-range wireless communication interface 130 communicates with the beacon terminal 40 and the reading device 20.

The reading device 20 includes an imaging device such as a CCD (Charge Coupled Device) and reads information concerning a commodity from an image captured by the imaging device. More in detail, the reading device 20 outputs, to the information processing device 10, code information obtained by reading or decoding a code symbol such as a barcode or a two-dimensional code attached on the surface of the commodity, and an image obtained by imaging the exterior of the commodity.

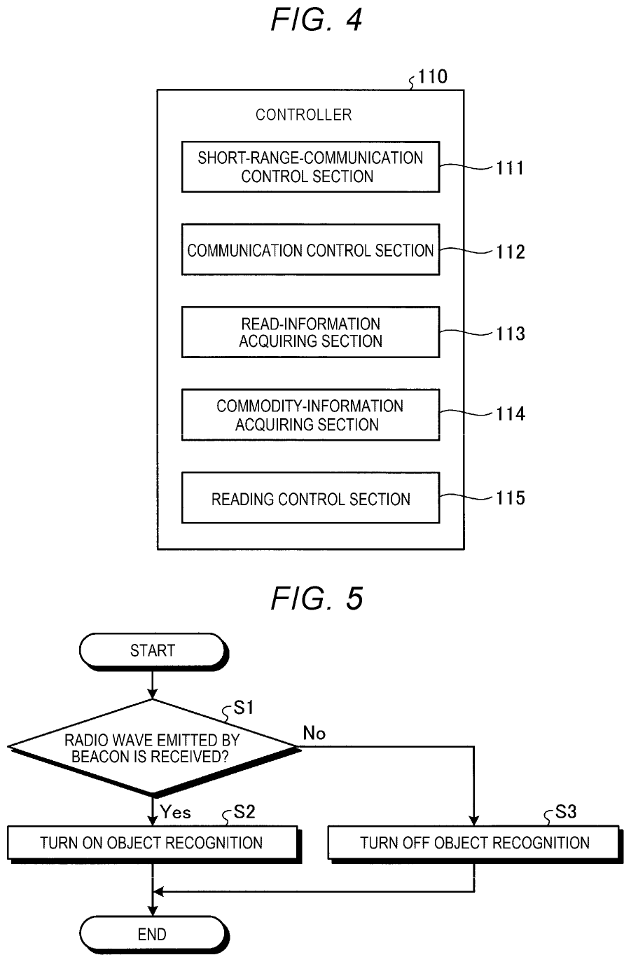

FIG. 4 is a diagram illustrating functional sections achieved by the controller 110 of the information processing device 10. The controller 110 includes a short-range-communication control section 111, a communication control section 112, a read-information acquiring section 113, a commodity-information acquiring section 114, and a reading control section 115. The controller 110 executes computer programs stored in the ROM and the storage device 120 to achieve the functional sections explained above.

The short-range-communication control section 111 controls the short-range wireless communication interface 130 to perform short-range wireless communication with the beacon terminal 40. For example, the short-range-communication control section 111 receives distribution information, such as beacon IDs, distributed from the beacon terminal 40 by broadcast. Additionally, the short-range-communication control section 111 controls the short-range wireless communication interface 130 to establish one-to-one communication with the reading device 20.

The communication control section 112 controls the communication interface 140 to perform communication with the server apparatus and the like. The read-information acquiring section 113 acquires the code information and the captured image input from the reading device 20.

The commodity-information acquiring section 114 is one example of a first commodity-information acquiring section and is one example of a second commodity-information acquiring section. The commodity-information acquiring section 114 extracts, from the PLU file, information concerning a commodity matching the code information and the captured image acquired by the read-information acquiring section 113.

More specifically, if the read-information acquiring section 113 acquires the code information, the commodity-information acquiring section 114 searches the PLU file for a commodity code matching the code information and acquires commodity information associated with the commodity code.

If the read-information acquiring section 113 acquires the captured image, the commodity-information acquiring section 114 performs object recognition based on the captured image to obtain a feature value, and acquires, from the PLU file, information concerning a commodity matching the feature value.

Concerning the object recognition for recognizing an object included in an image, a recognition technique is explained in, for example, a literature described below.

Keiji Yanai, “Present and Future of Generic Object Recognition”, Journal of the Information Processing Society of Japan, Vol. 48, No. SIG16.

The commodity-information acquiring section 114 switches an operation state of the commodity-information acquiring section 114 between a first operation state and a second operation state under the control of the reading control section 115 explained below. The commodity-information acquiring section 114 in the first operation state performs only commodity recognition based on code information and does not perform commodity recognition based on a captured image. The commodity-information acquiring section 114 in the second operation state performs the commodity recognition based on the captured image in addition to the commodity recognition based on the code information.

Upon receipt of a beacon ID from the beacon terminal 40, the reading control section 115 instructs the commodity-information acquiring section 114 to switch the operation state to the second operation state.

If a predetermined operation input is performed via the input device 13, the reading control section 115 instructs the commodity-information acquiring section 114 to switch the operation state to the second operation state. That is, for example, if a customer using the shopping cart 30 desires to perform commodity recognition irrespective of presence or absence of reception of a beacon ID, the information processing device 10 allows the customer to do so by switching the operation state to the second operation state with a predetermined operation.

Upon startup, the reading control section 115 instructs the commodity-information acquiring section 114 to operate in the first operation state. Thereafter, basically, the commodity-information acquiring section 114 maintains the first operation state and switches the operation state if an instruction for switching the operation state is given from the reading control section 115.

In such a configuration, the information processing device 10 stores, as information concerning a commodity to be purchased, in a predetermined region set in the storage device 120 or the like, commodity information of the commodity matching the code information or the captured image sent from the reading device 20.

A customer, who uses the shopping cart 30 to which the information processing device 10 and the reading device 20 are attached, causes the reading device 20 to read a commodity and thereafter puts the commodity in the shopping cart 30. The shopping cart 30 may include a scale that measures a total weight of commodities carried by the shopping cart 30. The information processing device 10 may receive an output of the scale and confirm whether the total weight increases by weight corresponding to the commodity read by the reading device 20.

The operation of the information processing device 10 is explained with reference to FIG. 5. FIG. 5 is a flowchart illustrating an example of processing executed in the information processing device 10.

If the controller 110 of the information processing device 10 functions as the short-range-communication control section 111 and receives a beacon ID of the beacon terminal 40 via the short-range wireless communication interface 130 (Yes in S1), the controller 110 functions as the reading control section 115 and turns on object recognition (aspect S2).

In this embodiment, the turning on the object recognition means instructing the commodity-information acquiring section 114 to switch the operation state to the second operation state. If the current operation state is the first operation state, the commodity-information acquiring section 114 receiving the instruction switches the operation state to the second operation state. If the current operation state is the second operation state, the commodity-information acquiring section 114 maintains the current operation state as it is.

In aspect S1, if the controller 110, functioning as the short-range-communication control section 111, does not receive the beacon ID of the beacon terminal 40 via the short-range wireless communication interface 130 (No in S1), the controller 110 functions as the reading control section 115 and turns off the object recognition (aspect S3).

In this embodiment, turning off the object recognition means instructing the commodity-information acquiring section 114 to switch the operation state to the first operation state. If the current operation state is the second operation state, the commodity-information acquiring section 114 receiving the instruction switches the operation state to the first operation state. If the current operation state is the first operation state, the commodity-information acquiring section 114 maintains the current operation state as it is.

In this embodiment, if the shopping cart 30 approaches the product display area 42 and the information processing device 10 (attached to the shopping cart 30) receives the beacon ID, the information processing device 10 switches the object recognition to ON in preparation for reading of the commodities without code symbol 41 such as vegetables and fruits. If the shopping cart 30 moves away from the product display area 42 and the information processing device 10 attached to the shopping cart 30 does not receive the beacon ID any more, the information processing device 10 switches the object recognition to OFF and performs commodity recognition based on a code symbol.

According to this embodiment explained above, the object recognition can be performed only near the product display area 42 in which the commodities without code symbol 41 are displayed. Consequently, for example, it is possible to abstain from the object recognition in a place where it is not assumed to perform reading of the commodities without code symbol 41.

Even when in the first operation state, in which the object recognition is not performed, the state can be manually switched to the second operation state by the customer's operation. Therefore, for example, a commodity without code symbol 41 brought from a product display area 42 by a companion of the customer controlling the shopping cart 30 at a position away from the particular product display area 42 from which the companion acquired the commodity without the code symbol 41, can be recognized by object recognition by manually switching the state to the second operation state as needed.

In this embodiment, the reading device 20 and the information processing device 10 communicate with each other by the wireless communication. However, in one embodiment, the reading device 20 and the information processing device 10 are not limited to this. For example, the reading device 20 and the information processing device 10 may communicate with each other by wired communication, the reading device 20 may be directly coupled to the information processing device 10, or the reading device 20 may be incorporated in the information processing device 10.

In this embodiment, the reading control section 115 instructs the commodity-information acquiring section 114 to switch the first operation state and the second operation state. However, in one embodiment, the reading control section 115 and the commodity-information acquiring section 114 are not limited to this.

For example, the commodity-information acquiring section 114 may be always in the second operation state in this embodiment. The reading control section 115 may instruct the read-information acquiring section 113 to switch execution and non-execution of acquisition of a captured image.

For example, the reading control section 115 may instruct the reading device 20 to switch the operation state. In this case, the commodity-information acquiring section 114 is always in the second operation state. The reading device 20 switches the operation state between the first operation state and the second operation state under the control of the reading control section 115. If detecting a code symbol from a captured image, the reading device 20 in the first operation state reads code information from the code symbol and outputs the code information to the information processing device 10. In addition, the reading device 20 in the second operation state outputs the captured image to the information processing device 10 if a code symbol cannot be detected from the captured image.

### Second Embodiment

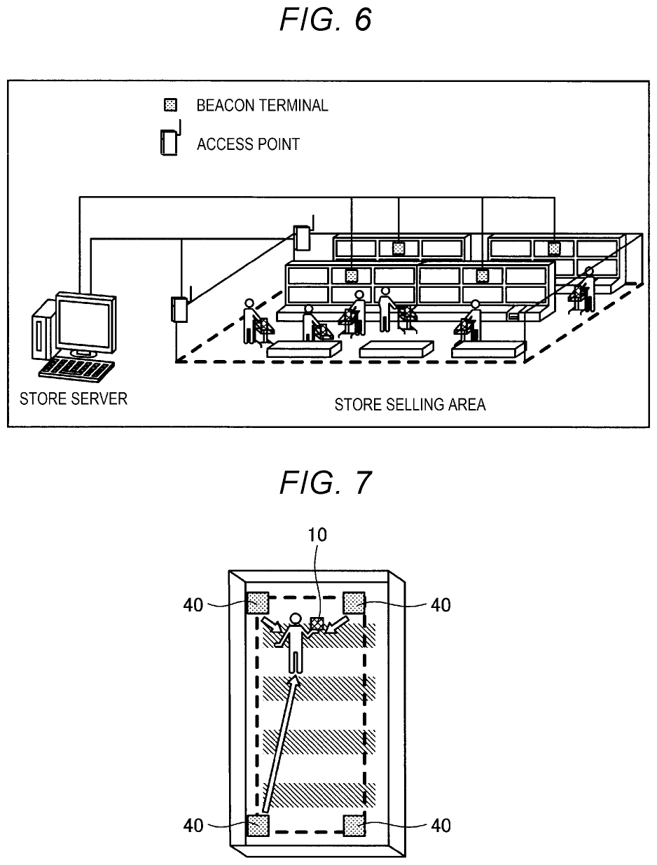

A second embodiment is explained below. In this explanation, the same components as the components in the first embodiment are denoted by the same reference numerals and signs. Detailed explanation of the components having the same functions is omitted. FIG. 6 is diagram illustrating disposition of beacon terminals in a store in this embodiment. In this embodiment, a plurality of beacon terminals 40 are generally uniformly disposed in the store. In the store, a plurality of access points covering wireless communication in the store are installed. The access points relay communication signals between the information processing device 10 and a store server.

The information processing device 10 in this embodiment stores map information in the storage device 120. The map information stores information indicating beacon IDs and positions of the beacon terminals 40 in the store, information indicating positions of display cases, bins, s or shelves for commodities, and information for determining whether the commodities displayed in the shelves are commodities with code symbol in association with one another.

FIG. 7 is a diagram illustrating a positional relation between the information processing device 10 and the beacon terminals 40. If the short-range wireless communication interface 130 is receiving signals of three or more beacons, the reading control section 115 in this embodiment calculates, based on the map information, the current position of the information processing device 10 from the positions of the beacon terminals 40 having the strongest radio wave intensity to the third strongest radio wave intensity of the signals. If the distance between the calculated position and the shelf 42 of the commodity without code symbol 41 is smaller than a predetermined threshold, the reading control section 115 sets the operation state of the information processing device 10 to the second operation state.

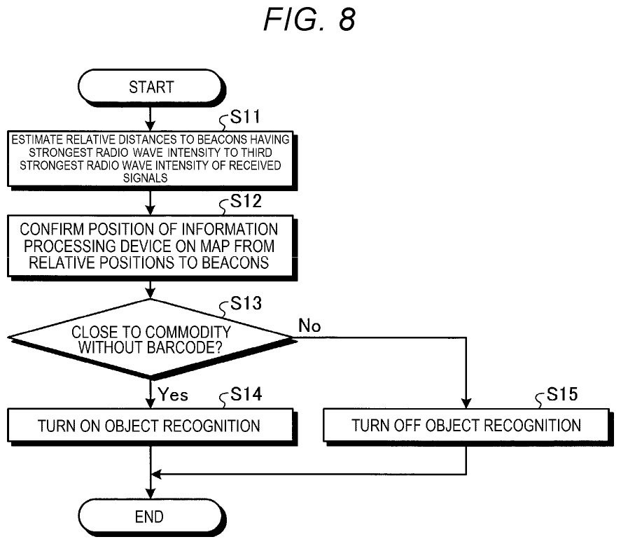

FIG. 8 is a flowchart illustrating a flow of the processing explained above executed by the information processing device 10. The reading control section 115 calculates relative distances to the beacon terminals 40 having the strongest radio wave intensity to the third strongest radio wave intensity of the received signals (Step S11). Any known method can be used for calculating a relative distance between two positions based on radio wave intensity.

Subsequently, the reading control section 115 refers to the map information and calculates a position of the information processing device 10 from the relative distances to the beacon terminals 40 (Step S12). More specifically, for example, the reading control section 115 sets, as the current position of the information processing device 10, an intersection of three circles drawn with the beacon terminals 40 as centers and with the relative distances calculated in Step S11 as radiuses.

Subsequently, the reading control section 115 determines whether the calculated position of the information processing device 10 is close to the commodity without code symbol 41 (Step S13). In Step S13, the reading control section 115 refers to the map information and determines whether the distance between the calculated position of the information processing device 10 and the shelf 42 of the commodity without code symbol 41 is smaller than a predetermined threshold. If the distance is smaller than the predetermined threshold, the reading control section 115 determines that the calculated position of the information processing device 10 is close to the commodity without code symbol 41.

If determining that the calculated position of the information processing device 10 is close to the commodity without code symbol 41 (Yes in Step S13), the reading control section 115 turns on the object recognition (Step S14). If determining that the calculated position of the information processing device 10 is not close to the commodity without code symbol 41 (No in Step S13), the reading control section 115 turns off the object recognition (Step S15).

As explained above, according to this embodiment, even in the store where the plurality of beacon terminals 40 are disposed, the information processing device 10 performs object recognition near commodities without code symbol 41 while suppressing unnecessary object recognition.

The computer programs executed in the information processing device 10 in the embodiments explained above are stored in the ROM or the like in advance.

The computer programs executed in the information processing device 10 in the embodiments explained above may be provided by a computer-readable recording medium, such as a CD-ROM, a flexible disk (FD), a CD-R, and a DVD (Digital Versatile Disk) or provided as installable or executable files.

Further, the computer programs executed in the information processing device 10 in the embodiments explained above may be stored and provided by a computer connected to a network such as the Internet and downloaded through the network. The computer programs executed in the information processing device 10 in the embodiments explained above may be provided or distributed through a network such as the Internet.

The computer programs executed in the information processing device 10 in the embodiments explained above have a module configuration by which the various functions of the sections explained above (e.g., the short-range-communication control section 111, the communication control section 112, the read-information acquiring section 113, the commodity-information acquiring section 114, and the reading control section 115) are provided. Typically, the processor or CPU reads out the computer programs from the storage medium and executes the computer programs to thereby load sections onto a main memory. Consequently, the short-range-communication control section 111, the communication control section 112, the read-information acquiring section 113, the commodity-information acquiring section 114, and the reading control section 115 are realized by the processor executing software programs or the like.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein maybe made without departing from the spirit of the present disclosure. The accompanying claims and their equivalents are intended to cover such forms or modifications as would fall within the scope and spirit of the present disclosure.

What is claimed is:

1. An information processing device on a shopping basket or a shopping cart, comprising:
a communication interface configured to communicate with an imaging device on the shopping basket or cart and beacons at product display areas; and
a processor configured to:
identify a commodity by either reading a commodity code included in an image of the commodity from the imaging device or performing object recognition on the commodity in the image, and
according to a signal received from at least one beacon, switch between a first mode in which the commodity is identified by reading the commodity code and a second mode in which the commodity can be identified by either reading the commodity code or object recognition.

2. The information processing device according to claim 1, wherein
in the second mode, the processor is configured to perform object recognition only after an attempt to identify the commodity by commodity code.

3. The information processing device according to claim 1, wherein
the processor is configured to switch to the second mode if the signal is received from the at least one beacon.

4. The information processing device according to claim 1, wherein
the processor is configured to switch to the first mode if signal is not received from any beacon.

5. The information processing device according to claim 1, wherein
upon receipt of signals from at least three beacons, the processor is configured to calculate a current position of the shopping basket or cart based on a strength of the signals.

6. The information processing device according to claim 5, wherein the processor is configured to:
calculate a distance from the shopping cart or basket to a product display area for a commodity without a commodity code attached, and
switch to the second mode when the distance is less than a threshold value.

7. The information processing device according to claim 1, further comprising:
an input device configured to receive an input for manually switching operation mode, wherein
the processor is configured to switch to the second mode upon receipt of the input.

8. The information processing device according to claim 1, wherein
the information processing device is a tablet terminal.

9. The information processing device according to claim 8, wherein the imaging device is between grips of the shopping cart.

10. The information processing device according to claim 1, wherein the communication interface communicates with the imaging device and the beacon according to a Bluetooth-type protocol.

11. A method for identifying a commodity using an information processing device and an imaging device installed on a shopping basket or a shopping cart, the method comprising:
receiving a signal from at least one beacon at a product display area;
switching the information processing device between a first mode, in which a commodity is identified by reading a commodity code on the commodity, and a second mode, in which the commodity is identified by either reading the commodity code or by object recognition, according to the received signal;
acquiring an image of the commodity with the imaging device; and
identifying the commodity in the acquired image according to whether the information processing device is in the first or second mode.

12. The method according to claim 11, wherein in the second mode, object recognition is performed after an attempt to identify the commodity by commodity code.

13. The method according to claim 11, wherein information processing device is switched to the second mode if the signal is received from the at least one beacon.

14. The method according to claim 11, wherein the information processing device is switched to the first mode if signal is not received from any beacon.

15. The method according to claim 11, further comprising:
receiving a signal from at least three beacons; and
calculating a current position of the information processing device based on strength of the signals.

16. The method according to claim 15, further comprising:
calculating a distance from the information processing device to a product display area for a commodity without a commodity code attached; and
switching to the second mode when the distance is less than a threshold value.

17. The method according to claim 11, further comprising:
receiving an input for manually switching operation mode of the information processing device, and switching to the second mode when the input is received by the information processing device.

18. The method according to claim 11, wherein the information processing device is a tablet terminal.

19. The method according to claim 18, wherein the information processing device communicates with the imaging device and the beacon according to a Bluetooth-type protocol.

20. An information processing system, comprising:
a beacon on a product display area;
an imaging device on a shopping basket or a shopping cart and configured to acquire an image of a commodity selected by a customer; and
an information processing device on the shopping basket or cart and comprising:
a communication interface configured to communicate with the beacon and the imaging device, and
a processor configured to:
identify a commodity by either reading a commodity code included in an image of the commodity from the imaging device or performing object recognition on the commodity in the image, and
according to a signal received from at least one beacon, switch between a first mode in which the commodity can be identified by reading the commodity code and a second mode in which the commodity can be identified by either reading the commodity code or object recognition.
